(19) United States
(12) Patent Application Publication
(10) Pub. No.: US 2006/0167767 A1
(43) Pub. Date: Jul. 27, 2006

(54) Countdown pricing process

(76) Inventor: Steven N. Verona, Margate City, NJ (US)

Correspondence Address: KREMBLAS, FOSTER, PHILLIPS & POLLICK, 7632 SLATE RIDGE BOULEVARD, REYNOLDSBURG, OH, 43068, US

(21) Appl. No.: 11/340,783

(22) Filed: Jan. 26, 2006

Related U.S. Application Data
(60) Provisional application No. 60/647,101, filed on Jan. 26, 2005.

(51) Int. Cl. G06Q 30/00

(52) U.S. Cl. 705/26

(57) ABSTRACT

A countdown pricing method in which products are offered for sale at a displayed price that decreases as time elapses. If a consumer wishes to purchase the product, he or she communicates an offer price to the seller, or the seller's web site acting as the seller's surrogate, which then determines whether a sale can be completed. So long as there is at least one such product available, the offer price is greater than the currently advertised price and a lowest acceptable price and the sale has not expired, then the sale is completed. Preferably, the seller notifies the consumer of either the acceptance or rejection of the offer price.

### CROSS-REFERENCES TO RELATED APPLICATIONS

(Not Applicable)

This application claims the benefit of U.S. Provisional Application No. 60/647,101 filed Jan. 26, 2005.

### STATEMENT REGARDING FEDERALLY-SPONSORED RESEARCH AND DEVELOPMENT

(Not Applicable)

### REFERENCE TO AN APPENDIX

(Not Applicable)

### BACKGROUND OF THE INVENTION

1. Field of the Invention

This invention relates generally to a method of selling goods and services, and more particularly relates to a method of selling in which the price of the products being sold decreases as time elapses.

2. Description of the Related Art

With conventional sales methods for products and services, buyers communicate, either to the world at large or to a particular seller, a price they are willing to pay for a given product or service. This occurs on web sites, such as PRICELINE.COM and on internet auction sites, including EBAY.COM. With PRICELINE.COM, product or service providers search the online listings for agreeable offers to buy. If they find an agreeable offer, the provider accepts the buyer's offer and a sale is made. Even more conventionally, providers advertise the products or services they wish to sell and the price for the product or service. The provider may later decrease the price, such as when a clearance sale occurs, but the consumer is left to guess when, if ever, that will occur.

With auction sites, product or service providers list their product or service at a starting price, and consumers communicate ever-increasing bids on the products until the sale is over. The highest bidding consumer purchases the item. This method is valuable for items that do not lose value as time passes, but is less useful for such items.

The invention contemplates an improved selling method that also contains entertainment value.

### BRIEF SUMMARY OF THE INVENTION

The invention is a method of selling products on a communications system, such as a web site. The communications system could alternatively be a television broadcast system, a chat room, a satellite radio broadcast system or a cable television system, among many others. If the communications system is a web site, a step in the method is a seller entering into the web site a quantity of the products available to be sold by the seller. The seller also enters into the web site a starting price for the products. This is the highest price at which products will typically be sold. The seller enters into the web site a starting time when selling of the products begins, and a lowest acceptable price at which the products can be sold. In a preferred embodiment, the seller enters into the web site an expiration time when selling of the products will cease

The web site subsequently displays the starting price and information about the products so that potential consumers can see the information and starting price. This display occurs no later than the starting time. At a predetermined time after the starting time, the web site displays a first lowered price. This first lowered price is lower than the starting price, and is displayed unless the quantity of products available has been sold. In the preferred embodiment, the predetermined time can be a particular number of minutes, or it can be a number of minutes or seconds that is randomly selected using known random calculators. If the predetermined time is randomly selected, the time is preferably selected soon after the first lowered price is displayed. Because the first lowered price is lower than the starting price, potential consumers who see the first lowered price displayed may become interested in purchasing the products due to the decreased price.

In a more preferred embodiment a predetermined time after the first lowered price is displayed, the web site displays a second lowered price that is lower than the first lowered price. This second lowered price is displayed unless one of the following events occurs: (i) the expiration time is reached; (ii) the second lowered price equals or falls below the lowest acceptable price; or (iii) the quantity of products available has been sold. In the first event, the time for selling the products has elapsed and the sale is over. In the second event, the second lowered price could not be accepted even if a consumer offered it, so it is not displayed. In the third event, the products are sold out, and so no more can be sold.

Potential consumers watching the displayed prices and product information can communicating an offer price to the seller in order to purchase one or more of the products. The seller can use the web site as a surrogate to receive the offer price and determine whether the offer price can be accepted. Thus, the consumer can communicate the offer price to the web site. If the products are still available and the offer price meets two criteria, the web site accepts the consumer's offer price for the seller. First, the offer price must be equal to or greater than the starting price or one of the lowered prices. Second, the offer price must be equal to or greater than the lowest acceptable price. If the criteria are not met, the web site rejects the offer price. In a preferred embodiment, the web site communicates to the consumer the acceptance or rejection of the offer price.

The price of the product can be reduced virtually an unlimited number of times until either the sale expires or the products are all sold. Although only two lowered price displays are discussed above, there can be many more, such as five to 50 such price reductions.

### BRIEF DESCRIPTION OF THE SEVERAL VIEWS OF THE DRAWINGS

FIG. 1 is a flowchart illustrating one embodiment of the present invention.

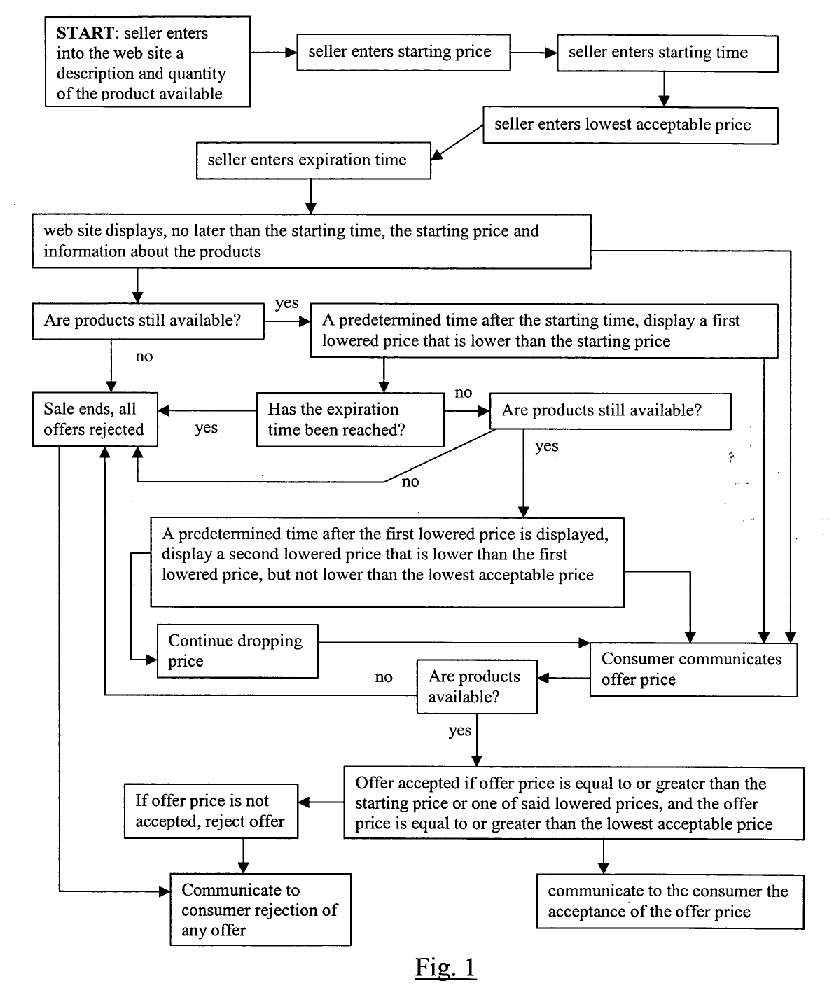

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or term similar thereto are often used. They are not limited to direct connection, but include connection through other elements where such connection is recognized as being equivalent by those skilled in the art.

### DETAILED DESCRIPTION OF THE INVENTION

The present invention uses a communications system to communicate prices at which products are offered for sale to potential consumers. The preferred embodiment of the invention uses a web site as the communications system, but it will become apparent to the person having ordinary skill that the method could be carried out or performed using a television broadcast, such as an infomercial, a radio broadcast, a bulletin board (BBS), email communication, internet banner advertising, live presentation or any other mode of communication that permits information to be communicated to an audience. Of course, the invention can be integrated into an existing web site or on its own web site.

In the web page embodiment, the seller of products or services begins the process by entering into the web site a description and a quantity of products available. Typically, this will be for one product of which the seller has many copies, such as copies of the movie TOY STORY on DVD. Preferably, the seller does so by manually entering the information into the web site, but the entry process can be automated using conventional hardware and software. The quantity of products available can be the actual number of products the seller has on hand, or the number the seller wishes to sell.

The seller enters a starting price into the web site, which starting price represents the price that will first be displayed to potential consumers, and the highest price that will be paid for any of the products. The seller enters a starting time into the web site, which is the time the selling will begin. This can be a few moments after the seller anticipates entering the information into the web site, or it can be significantly later. The seller enters into the web site a lowest acceptable price, which represents the lowest price at which the products can be sold. The seller can enter an expiration date and time at which the selling of products must end. This is optional, because the sale could be concluded, as will be seen below, by the displayed price falling below the lowest acceptable price. Nonetheless, some products expire at a particular time, and this step may be desirable in those, or other, instances.

It should be noted that in the description herein, the term “product” includes goods and services. Therefore, for example, a “product” can be a book, a hotel room reservation, a cell phone or an automobile rental reservation. Likewise, the term “communications system” includes any system by which information is communicated to an audience consisting of multiple potential consumers. Communication systems include not only the equipment by which communication takes place, but also the people who work on the communications system. Thus, when reference is made to communicating information to the communications system, this includes communicating that information to a human being who is involved in that system.

Considering the web site example, and with the understanding that persons of ordinary skill will understand how to adapt the invention to any communications system, the web site displays the starting price for the product at the starting time. Also displayed is information about the product, such as a title, description and a photograph or illustration. This can be displayed on a web site, and the text and graphics can be searchable by potential consumers much like occurs on the web site for EBAY. Alternatively, the display can occur in the form of an email, a banner advertisement or a television commercial.

In the web page example, the price displayed begins at the starting price, but after a predetermined time has elapsed since the starting time, a first lowered price is displayed. After another predetermined time has elapsed since the first lowered price is displayed, a second lowered price is displayed. The first lowered price is lower than the starting price, and the second lowered price is lower than the first lowered price. These falling prices are displayed at predetermined time intervals between one another, which will create interest by potential consumers.

The predetermined time intervals can be set numbers of seconds or minutes, such as 10 minutes, 60 seconds or 60 minutes, and can be the same between each price change. Alternatively, the predetermined time intervals can begin with a predetermined time and then decrease after each price change. For example, the first time could be 10 minutes, the second could be nine minutes, the third eight minutes and so on to create a sense of urgency to purchase at that price. Alternatively, the amount of time could increase to give consumers more time to purchase at the lower, and therefore more attractive, price. Furthermore, the predetermined time could be randomly selected time intervals, if desired, thereby eliminating all predictability as to when the next price change will occur. Still further, the price can drop at a rate that is a function of the number of products that remain unsold, or the number of products that have been sold. Thus, the predetermined time in this example is affected by measured quantities of products.

The displayed price is reduced one, two, three, four or more times until one of the following events occurs. First, if there is an expiration time, the sale will end when that time is reached. Second, if the displayed price goes to zero or becomes equal to or greater than the lowest acceptable price, the sale will end. Finally, if all of the products are sold out or another event occurs, which could include any combination of events, the sale ends. The lowering of the displayed price at time intervals is known as the “price countdown” and is desirable to potential consumers, who see the method as a way to save money on their purchases in combination with a strategy to purchase the products at the lowest price before they are sold out or fall below the lowest acceptable price, which may not be known to the potential consumer.

It is important to note that the number of times the price is reduced is limited by the starting price, the lowest acceptable price and the amount of the difference between the two prices that the seller wishes to reduce the price each time there is a reduction. For example, if the starting price is $100.00 and the lowest acceptable price is $50.00, and the seller will reduce the price ten dollars each time there is a reduction, then there will be five reductions in price until the lowest acceptable price is reached. The price could be reduced further just to see how many people would purchase at the lower cost, even though no sales would be made at this price. However, this has the inherent risk of frustrating potential consumers.

During the price countdown on the web page example, a consumer can input to their computer to communicate to the web page an offer price at which the consumer will purchase the product. Typically, this input will be accomplished using a mouse or other pointing device to click on a graphic image that represents acceptance of the displayed price, but could include a keyboard, voice-activated software, etc., and will vary depending upon the technology of the communications system. For example, with a television or radio embodiment, the consumer can use a telephone to speak to a human or use a menu-driven answering system to communicate an offer price. If the communications system is a live audience, the consumer could simply stand and verbally speak his or her offer price. The number of means of communicating the offer price is virtually endless, as will become apparent to the person having ordinary skill.

If, when the consumer communicates his or her offer price, the product is still available, the offer price is greater than the lowest acceptable price and the sale has not expired, then the sale will be completed. If the product is no longer available, or the price is below the lowest acceptable price, then there is no sale and the offer price is rejected by the seller. This can take place by the web page software comparing the offer price to the lowest acceptable price and comparing the offer time to the expiration time. In a preferred embodiment, the consumer is informed of the acceptance or rejection of the offer price, although this is not necessary in every case. Each sale occurs when the consumer's offer is accepted, not when they communicate the offer. The sale can be automated to use an existing account containing funds, or can be tied to a credit card or other payment means, such as PAYPAL, etc.

Potential consumers are entertained by watching the displayed price for the product decrease, and are challenged by deciding at what price to purchase the product. If the consumer waits too long to accept the price there may not be any products left or it may be below the lowest acceptable price. Under these circumstances, no sale occurs even if an offer price is communicated. Thus, although waiting decreases the price of the product, it also decreases the probability of a sale occurring. However, if the consumer waits some amount of time, they will pay a lower price.

This method is an ideal process for merchants to sell their goods and services as people are motivated to participate in the “action”, which will prompt consumers to make purchases before it is “too late”. It will also offer the merchant the chance to capture a higher selling price from consumers who do not want to lose the purchase at a price that they consider a good deal, which may be a different price than others would consider a good deal. This sales method is especially effective for services that “expire” at a predetermined time, such as airline tickets, hotel rooms, and rental cars, and that would otherwise be “wasted” by not selling for something above the lowest acceptable price.

The web site or other communications system may display to the consumer the quantity of products still available, but may not, depending upon many marketing factors, such as whether people are likely to buy when they see the product's numbers dwindling, etc. Furthermore, the prices at which particular products sell can be tracked to establish patterns that might reveal optimum and/or perceived values based on sales volume at certain prices. This marketing information can then be used for future sales.

The method will attract potential consumers to stay on the web site to watch the prices drop, which may result in advertising revenue even if less than all potential consumers purchase products. Additionally, the excitement generated by the “sale” environment will inspire people to return frequently to the site to see where the prices are, and how many are left, if this is displayed.

As with any online or other business, consumers can sign up for an account so that they can “click” their mouse to complete the purchase without wasting time entering payment information. This payment information can then be available for approval like a normal website or other business that stores credit card information. The consumer may choose to place a charge on his credit card and have funds available immediately to complete the transaction instantly without waiting for credit card approval. In this instance, any interest obtained from holding the money could add to the web site operator's profits.

All parameters for the sale can be entered and edited on the web site directly by a third party provider such as a hotel, airline, manufacturer, distributor, etc. This minimizes the number of employees the web site operator needs to employ. Consumers can also instruct the web site to send them price alerts (e.g., by email, instant message, etc.) when a product's price declines to a target price.

The invention can also be remotely served to third party sites. For example, a small company may want to offer the sales method to consumers, but it may not have the resources to fully integrate the method into its own web site. Therefore, one embodiment of the invention includes the step of offering the service to the small company's web site via plug-in. Furthermore, banner ads can serve up an offer with the countdown price and the user can click the ad to purchase.

While certain preferred embodiments of the present invention have been disclosed in detail, it is to be understood that various modifications may be adopted without departing from the spirit of the invention or scope of the following claims.

1. A method of selling products on a web site comprising:
(a) a seller entering into the web site a quantity of the products available;
(b) a seller entering into the web site a starting price for at least one of the products;
(c) a seller entering into the web site a starting time when selling of the products begins;
(d) a seller entering into the web site a lowest acceptable price at which the products can be sold;
(e) a seller entering into the web site an expiration time when selling of the products will cease;
(f) the web site displaying, no later than the starting time, the starting price and information about the products;
(g) the web site displaying, a predetermined time after the starting time, a first lowered price that is lower than the starting price unless the quantity of products available has been sold;
(h) the web site displaying, a predetermined time after the first lowered price is displayed, a second lowered price that is lower than the first lowered price unless one of the following events occurs:
(i) the expiration time is reached;
(ii) the second lowered price falls below the lowest acceptable price; or
(iii) the quantity of products available has been sold;
(i) a consumer communicating an offer price to the web site to purchase one of the products;
(j) the web site accepting the offer price if at least one of the products is available and the offer price is equal to or greater than the starting price or one of said lowered prices, and the offer price is equal to or greater than the lowest acceptable price;
(k) the web site rejecting the offer price if the quantity of products available has been sold, the offer price is less than the starting price and all of said lowered prices, or the offer price is less than the lowest acceptable price; and
(l) communicating to the consumer the acceptance or rejection of the offer price.

2. The method in accordance with claim 1, further comprising offering to host the web site of another.

3. The method in accordance with claim 1, further comprising displaying products and their prices by banner advertisements.

4. The method in accordance with claim 1, further comprising the web site displaying, a predetermined time after the second lowered price is displayed, a third lowered price that is lower than the second lowered price unless one of the following events occurs:
(i) the expiration time is reached;
(ii) the third lowered price falls below the lowest acceptable price; or
(iii) the quantity of products available has been sold.

5. A method of selling products using a communication system, the method comprising:
(a) a seller communicating to the communication system a quantity of the products available;
(b) the seller communicating to the communication system a starting price for at least one of the products;
(c) the seller communicating to the communication system a starting time when selling of the products begins;
(d) the seller communicating to the communication system a lowest acceptable price at which the products can be sold;
(e) the communication system communicating to potential consumers, no later than the starting time, the starting price and information about the products;
(f) the communication system communicating to potential consumers, a predetermined time after the starting time, a first lowered price that is lower than the starting price;
(g) a consumer communicating an offer price to the seller to purchase one of the products, said offer price being equal to or greater than the starting price or said first lowered price, and the offer price being equal to or greater than the lowest acceptable price;
(h) the seller accepting the offer price.

6. The method in accordance with claim 5, further comprising the seller communicating an expiration time when selling of the products will cease.

7. The method in accordance with claim 6, further comprising the communication system communicating to potential consumers, a predetermined time after the first lowered price is displayed, a second lowered price that is lower than the first lowered price unless one of the following events occurs:
(i) the expiration time is reached;
(ii) the second lowered price falls below the lowest acceptable price; or
(iii) the quantity of products available has been sold.

8. The method in accordance with claim 6, further comprising the seller rejecting the offer price if the quantity of products available has been sold, the offer price is less than the starting price and said first lowered price, or the offer price is less than the lowest acceptable price

9. The method in accordance with claim 8, further comprising the seller communicating to the consumer the acceptance or rejection of the offer price.

10. The method in accordance with claim 5, further comprising the seller communicating to the consumer the acceptance of the offer price.

11. The method in accordance with claim 7, further comprising the communication system communicating to potential consumers, a predetermined time after the second lowered price is displayed, a third lowered price that is lower than the second lowered price unless one of the following events occurs:
(i) the expiration time is reached;
(ii) the third lowered price falls below the lowest acceptable price; or
(iii) the quantity of products available has been sold.
